(19) United States
(12) Patent Application Publication
(10) Pub. No.: US 2015/0244604 A1
(43) Pub. Date: Aug. 27, 2015

(54) TESTING POWERLINE COMMUNICATION DEVICES

(71) Applicant: QUALCOMM Incorporated, San Diego, CA (US)

(72) Inventors: Francisco Javier Moreno, Ocala, FL (US); Purva Rameshchandra Rajkotia, Orlando, FL (US)

(21) Appl. No.: 14/611,536

(22) Filed: Feb. 2, 2015

Related U.S. Application Data
(60) Provisional application No. 61/943,872, filed on Feb. 24, 2014.

(51) Int. Cl. H04L 12/26; H04L 12/721; H04L 29/06

(52) U.S. Cl. CPC H04L 43/0882; H04L 67/42; H04L 45/66

(57) ABSTRACT

Testing procedures and associated messaging can be performed via powerline communication (PLC) medium. A first device can test a second device using management messages via the PLC medium. For example, the first device may transmit a test setup request message including at least one test parameter to the second device via the PLC medium. The first device may conduct a test of the second device in accordance with the at least one test parameter. The first device may determine a first performance metric associated with the test. The first performance metric can describe at least one of a PLC interface of the second device and the PLC medium between the first device and the second device. Test results can be translated to a common format for comparison to traditional tests which may be based on Ethernet performance metrics.

### RELATED APPLICATIONS

This application claims the priority benefit of U.S. Provisional Application Ser. No. 61/943,872 filed Feb. 24, 2014.

### TECHNICAL FIELD

Embodiments of the present subject matter generally relate to the field of communication devices and, more particularly, to powerline communication (PLC) devices.

### BACKGROUND

Network devices have evolved to operate with multiple communication technologies (e.g., various combinations that may include wireless local area network (WLAN) technologies, PLC technologies, and multimedia over coaxial (MoCA), IEEE 1901, Ethernet, etc.). Each communication technology may have unique requirements such as protocols, message formats, and testing procedures.

To ensure that a network device meets networking specifications, performance requirements, and/or regulations, testing procedures may be executed to confirm that the device operates in accordance with each relevant communication technology. Testing may also be referred to as “certification” or “validation.” However, testing procedures for a first communication technology (e.g., Ethernet) may not be applicable to a second communication technology (e.g., PLC). Furthermore, performance of a communication medium may be determined differently for different communication technologies.

### SUMMARY

Disclosed are testing procedures and associated messaging to test a PLC device and performance of a PLC medium. In one embodiment, a first device transmits a test setup request message including at least one test parameter to a second device via a powerline communication (PLC) medium. The first device conducts a test, via the PLC medium, of the second device in accordance with the at least one test parameter. The first device determines a first performance metric associated with the test.

In other embodiments, the first device may cause the second device to transmit a test traffic message to the first device. The first device can receive the test traffic message from the second device and determine a second performance metric associated with the first device based, at least in part, on the test traffic message.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating an embodiment of testing a PLC device;

FIG. 2 is a conceptual diagram illustrating an example format of a message that is used for testing a PLC device;

FIG. 3 is a messaging diagram describing a messaging sequence for testing a PLC device;

FIG. 4 is an example conceptual diagram illustrating another embodiment of testing a PLC device associated with a host device;

FIG. 5 is a flow diagram illustrating example operations for testing a PLC device;

FIG. 6 is a flow diagram illustrating further example operations for testing a PLC device; and

FIG. 7 is a block diagram of one embodiment of an electronic device including a mechanism for testing a PLC device.

### DESCRIPTION OF EMBODIMENT(S)

The description that follows includes exemplary systems, methods, techniques, instruction sequences, and computer program products that embody techniques of the present subject matter. However, it is understood that the described embodiments may be practiced without these specific details. For instance, although examples refer to using a high-definition multimedia interface (HDMI) protocol for testing an embedded PLC device, embodiments are not so limited. In other embodiments, other suitable communication protocols and standards (e.g., a serial peripheral interface (SPI) protocol, a universal serial bus (USB) protocol, a universal asynchronous receiver/transmitter (UART), User Datagram Protocol (UDP), Transmission Control Protocol (TCP), etc.) may be used for testing the embedded PLC device. Additionally, although examples refer to testing a PLC device, in other embodiments, the test operations described herein may be executed to test network devices that implement other suitable communication protocols (e.g., multimedia over coax alliance (MoCA®)). In other instances, well-known instructions, protocols, structures, and techniques have not been shown in detail in order not to obfuscate the description.

PLC devices typically include an Ethernet interface in addition to a PLC interface. Conventional testing techniques for testing the PLC devices rely on the Ethernet interface and the Ethernet communication protocol. For example, current HomePlug® certification procedures describe testing a PLC device using the Ethernet communication protocol. In the conventional testing techniques, the PLC device may be coupled with an external testing device using the Ethernet interface of the PLC device. The external testing device may test and certify the PLC device by exchanging Ethernet messages with the PLC device via the Ethernet interface and in accordance with Ethernet-based test parameters.

However, PLC devices may not include an Ethernet interface or may not implement an Ethernet protocol due to, for example, expense and/or size of implementing the Ethernet interface on a PLC device, or due to a lack of requirements for an Ethernet interface in an embedded PLC device. Therefore, existing testing techniques may be unsuitable to test this type of PLC device.

In the present disclosure, PLC medium may be used for testing/certifying a PLC device. The PLC device being tested may or may not include an Ethernet interface. More specifically, a testing procedure using a PLC protocol via a PLC medium may be implemented. In one embodiment, a first PLC device can generate test messages and test the performance of a second PLC device without using a separate external testing device or an additional network interface (e.g., the Ethernet interface). Test procedures may be based on a server-client pseudo-relationship where a server PLC device (e.g., a first PLC device) transmits test messages via the PLC medium to a client PLC device (e.g., a second PLC device). The designation of server and client are used herein merely as descriptive of a relationship between two PLC devices in which the server PLC device has responsibility to send test traffic and/or manage the test procedures.

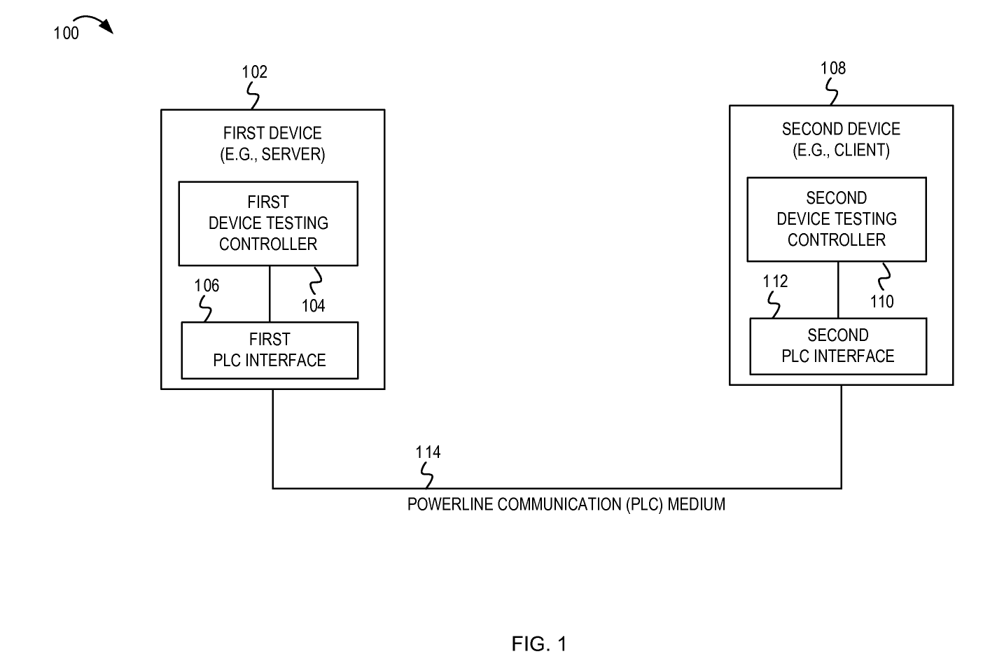

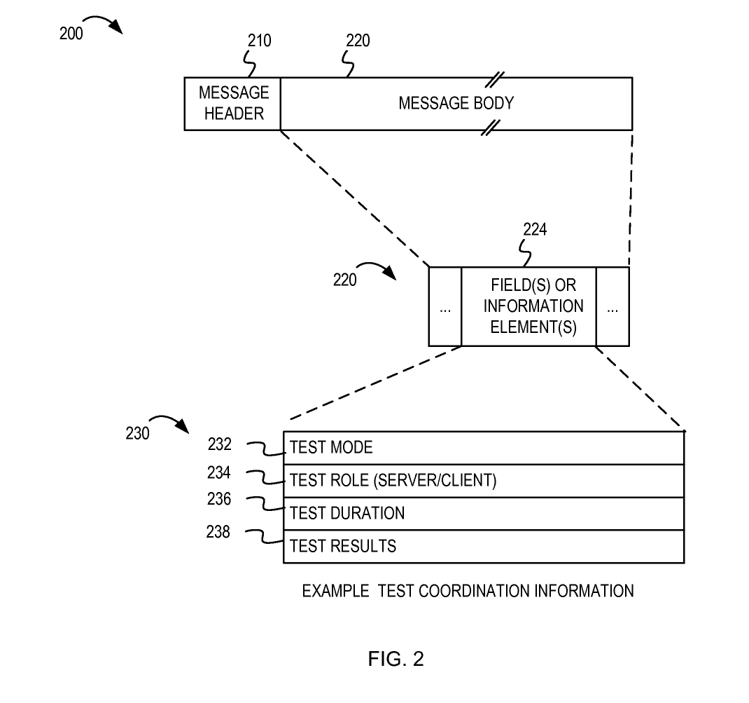

The server PLC device may estimate the performance (referred to as “PLC-based performance”) of the client PLC device by conducting the test via the PLC medium as will be further described with reference to FIGS. 1 and 2. In one embodiment, the test may be configured to also estimate the performance (e.g., bandwidth) of the PLC medium. In another embodiment, the PLC-based performance may be translated to an Ethernet-based performance metric. For example, the Ethernet-based performance metric may be used to compare the performance of the client PLC device against other PLC devices that were tested using the conventional testing techniques via the Ethernet medium. In some embodiments, if the server PLC device is embedded in or coupled to a host device, the host device can drive operations for testing the client PLC device. For example, in one embodiment, the host device may implement a high-speed serial data transmission protocol to transmit test messages in data packets via the PLC device without affecting communication efficiency.

FIG. 1 is a conceptual diagram illustrating an embodiment of testing a powerline communication (PLC) device. FIG. 1 depicts a communication network 100. In FIG. 1, a first device 102 and a second device 108 are part of the communication network 100. The first device 102 includes a first device testing controller 104 and a first PLC interface 106. Likewise, the second device 108 includes a second device testing controller 110 and a second PLC interface 112. The first PLC interface 106 of the first device 102 is communicatively coupled with the second PLC interface 112 of the second device 108 via a PLC medium 114. Although not depicted in FIG. 1, the communication network 100 may include additional PLC devices. The communication network 100 may be referred to as a PLC network. The PLC network may be associated with one or more PLC protocols, such as HomePlug® AV/AV2/GreenPHY protocols, G.hn protocols, or other suitable protocols that use a powerline medium for communication. In some embodiments, one or both of the first and second devices 102, 108 may be embedded PLC devices. Embedded PLC devices refer to PLC devices that are embedded within other electronic devices, such as a television, a desktop computer, a laptop computer, a tablet computer, a smart appliance, a gaming console, a television set-top box (or set-top unit), a media player, or another suitable electronic device. In another embodiment, one or both of the first and second devices 102, 108 may each be a standalone PLC device, such as a PLC modem.

As will be further described below, the first and second device testing controllers 104, 110 may execute operations (referred to herein as test/testing operations, or test/testing procedures) for: 1) conducting a test on a PLC interface, 2) self-generating test traffic messages on the PLC medium, and/or 3) determining performance metrics based on information received from the device being tested (sometimes referred to as the device under test, or DUT). Test control messages (e.g., messages for setting up, starting, stopping, synchronizing, and monitoring the test, and requesting test results) may be sent between the first and second devices to coordinate a test procedure.

The test procedure may be used to test functionality of an embedded PLC device. In one example, the first device may be a computer while the second device may be a television. Either or both of the computer and the television may have embedded PLC devices. However, one or both of the computer and the television may not have an Ethernet interface available to coordinate testing of its respective embedded PLC device. In one example, the embedded PLC device (e.g., first device) within the computer may connect via the PLC medium to the embedded PLC device (e.g., second device) within the television. Using a test procedure described herein, the embedded PLC device within the computer can test the performance of the embedded PLC device within the television, and test the performance (e.g., bandwidth, noise level, etc.) of the PLC medium between the two embedded PLC devices.

The first device 102 and the second device 108 may each include functionality to operate in a server operating mode or a client operating mode depending on which device is being tested. Referring to FIG. 1, a user may cause one of the first or second devices 102, 108 to initiate operations for testing the other one of the first or second devices 102, 108. For example, the user may activate a trigger unit (not shown) associated with the first device 102 to initiate the test operations. Activating the trigger unit may include pressing a button associated with the first device 102, pressing a virtual button presented on a display unit (not shown) of the first device 102, triggering a switching unit (not shown), or the like. In some embodiments, a remote control may be used to wirelessly activate the trigger unit associated with the first device 102. For example, a user may press a remote control button to activate the trigger unit associated with the first device 102 and to initiate the test operations. Other types of activation means, in addition to a trigger unit, can be used in other embodiments. The device (e.g., the first device 102) that is associated with the activated trigger unit can activate a server operating mode in response to the activated trigger unit. As will be further described below, activating the server operating mode in a first device may cause the first device to execute the test operations to test a second device in the communication network 100.

In one embodiment, the first device testing controller 104 may detect the second device 108 in response to a communication via the PLC medium 114. The first device testing controller 104 may determine to test the second device 108 in response to detecting the second device 108, or in response to activation of the test by a user. For example, the first device testing controller 104 may be activated to test the performance or standards compliance of the second PLC interface 112 in the second device 108.

This disclosure provides several examples of tests that may be performed. The tests may be performed to collect different performance metrics associated with the PLC device being tested or associated with the PLC medium. For example, the performance metrics may include one or more of: compliance with control messages, a number of bytes received, a time elapsed for the test, a signal to noise ratio, a quality metric for the PLC medium, a transmission data rate, a bit error rate, attenuation, or the like. In one example, the performance metrics may describe the performance of a tested device relative to other PLC devices or relative to a standard for powerline communications. In another example, the performance metrics may describe the PLC medium between two devices. Examples of different tests, described below, include a unidirectional test, a bidirectional test, and a mirror (loopback) test. One or more of the tests may be performed.

A unidirectional test may be used to estimate performance metrics based on test traffic messages sent in one direction on the PLC medium. For example, in a unidirectional test, the second device testing controller 110 may estimate performance metrics of the second PLC interface 112 based on the test traffic messages received from the first device 102. The second device testing controller 110 may determine the number of bytes of the test traffic messages that were received from the first device 102, the time interval between the first device transmitting the test traffic messages and the second device receiving the test traffic messages (“transit time”), attenuation of the test traffic messages, the signal-to-noise ratio (SNR) of the retransmitted test traffic messages, etc. The second device testing controller 110 may then transmit the performance metrics as the test results to the first device 102.

A bidirectional test (sometimes also referred to as a synchronized bidirectional test) may involve test traffic messages sent in both directions on the PLC medium. For example, in a bidirectional test, the first and second device testing controllers 104, 110 may exchange synchronization messages and agree on traffic parameters. For example, first and second device testing controllers 104, 110 may exchange test control messages and negotiate the test parameters for conducting the test. After selecting the test parameters, the first device 102 and the second device 108 may concurrently transmit test traffic messages. For example, the first device 102 may transmit a first set of test traffic messages to test the performance of the second PLC interface 112 of the second device 108. At the same time, the second device 108 may transmit a second set of test traffic messages to test the performance of the first PLC interface 106 of the first device 102. Alternatively, the first device 102 may transmit test traffic messages to test the performance of the second device 108; while the second device 108 may concurrently transmit data messages (e.g., including actual data and not test data) to the first device 102.

Another type of test is a mirror or loopback test, in which test traffic messages are sent in a one direction via the PLC medium and are retransmitted back in the reverse direction via the PLC medium. For example, in a mirror or loopback test, the second device 108 may simply retransmit the test traffic messages received from the first device 102 back to the first device 102. In this embodiment, the retransmitted/mirrored test traffic messages may be analyzed by the first device 102 to determine the test results. The first device testing controller 104 may estimate performance metrics associated with the second PLC interface 112 of the second device 108 based on a comparison of the originally transmitted test traffic messages and the retransmitted test traffic messages received from the second device 108. For example, the first device testing controller 104 may determine the number of bytes of the test traffic messages that were transmitted from the first device 102, the number of bytes of the retransmitted test traffic message that were received from the second device 108, the round-trip transit time, the attenuation of the retransmitted test traffic messages, the SNR of the retransmitted test traffic messages, etc.

In another embodiment of a loopback test, the first device 102 may transmit multiple test traffic messages to the second device 108. The second device 108 may temporarily buffer the received test traffic messages. In response to receiving an instruction from the first device 102, the second device 108 may retransmit the buffered test traffic messages to the first device.

In some embodiments, the first device testing controller 104 of the first device 102 (configured in the server operating mode) may determine whether the second device 108 should transmit the test results using the loopback test mode, the unidirectional test mode, or the bidirectional test mode. As described above, the first device testing controller 104 may indicate the test mode as one of the test parameters of the test setup request message. In one embodiment, the first device 102 may be preconfigured to use a particular test mode for receiving the test results. In another embodiment, the first device 102 may randomly select a test mode for receiving the test results. In another embodiment, the first device 102 may select the test mode based on processing capabilities of the first device 102 and/or the second device 108. In some embodiments, the first device 102 may conduct the test twice—for example, one test using the loopback test mode and the other test using the unidirectional test mode. In another embodiment, however, the first device 102 may conduct the test only once using any one of the test modes.

In some embodiments, the first device testing controller 104 may also translate (e.g., “convert”) the performance metrics determined using the PLC medium (“PLC-based performance metrics”) to Ethernet-based performance metrics. The first device testing controller 104 may use a PLC-to-Ethernet conversion mapping (or a PLC-to-Ethernet conversion algorithm) to determine the Ethernet-based performance metrics from the PLC-based performance metrics. In one example, the PLC-to-Ethernet conversion mapping may be determined by testing embedded PLC devices using both the PLC medium and the Ethernet medium and identifying a relationship between the PLC-based performance metrics and the Ethernet-based performance metrics. By translating the PLC-based performance metrics to Ethernet-based performance metrics, the second device 108 (e.g., the Second PLC interface 112) can be compared against other devices (e.g., PLC interfaces) that were previously tested using the Ethernet medium.

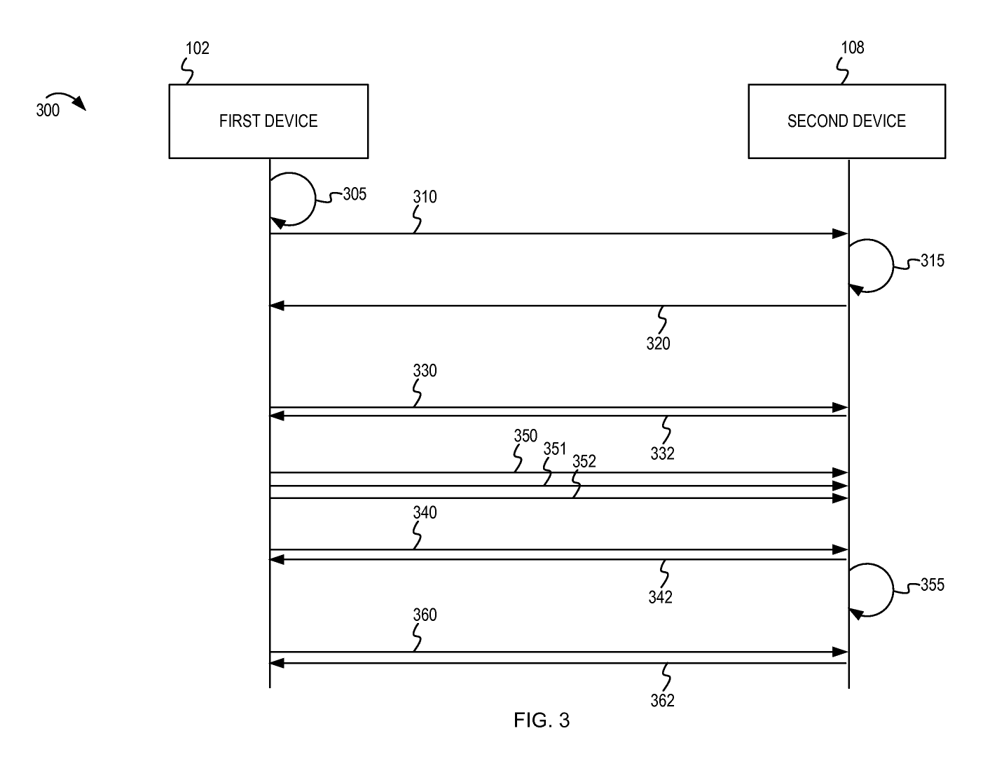

FIG. 2 is a conceptual diagram illustrating an example format of a message 200 that is used for testing a PLC device. The message 200 includes a message header 210 and a message body 220. The message header 210 may include a source address field and a source destination field. The message body 220 may include message fields 224 (which may also be referred to as information elements (IE)). The message body 220 may also include control information and/or data (payload) to be transmitted to a receiving device. FIG. 2 depicts example test coordination information 230 that may be transmitted in the message fields 224. For example, the message fields 224 may indicate a test mode 232, a test role 234 (e.g., whether server or client), a test duration 236, test results 238, and/or other suitable information as will be further described. The message format of FIG. 2 may be used to represent test control messages or test traffic messages. The test traffic messages may include test data that is transmitted to test the performance of the PLC interface of a device. Examples of test control messages are described further in FIG. 3. The example test control messages include:
A test setup request message transmitted by a first device operating in the server operating mode to configure a second device in the client operating mode for subsequently testing a PLC interface of the second device.
A test setup confirmation message that indicates whether the second device can operate in the client operating mode and execute the test operations.
A test start (or stop) message transmitted by the first device to notify the second device that transmission of the test traffic messages will begin (or end)
A test start (or stop) confirmation message transmitted from the second device to acknowledge receipt of the test start (or stop) message.
A test results request message transmitted from the first device requesting test results from the second device after transmitting the test traffic messages.
A test results confirmation message transmitted from the second device to acknowledge receipt of the test results request message and to transmit the test results to the first device.

FIG. 3 is a messaging diagram describing a messaging sequence for testing a PLC device. In various embodiments, one or more of the messages may be omitted in a testing protocol. The messaging diagram 300 illustrates an example of a unidirectional test in which a first device 102 behaves as a server device for the test while the second device 108 is the client device. The device being tested in FIG. 3 is the second device 108. Some or all of the messages described in FIG. 3 may generated or processed by a device testing controller (such as the first device testing controller 104 and the second device testing controller 110 described in FIG. 1).

In FIG. 3, the test procedure may be initiated as a result of the first device 102 detecting (shown at 305) activation of a trigger unit. To initiate the test procedure, the first device 102 may generate and transmit a test setup request message 310 to the second device 108. Receiving the test setup request message 310 may prompt the second device 108 to initiate the corresponding steps for the test procedure at the second device 108. The test setup request message 310 may instruct the second device 108 to activate a client operating mode for the purposes of a test. The test setup request message 310 may also indicate a test procedure from a plurality of test procedures that can be conducted. In one test procedure (referred to as a unidirectional mode test), the second device 108 will estimate performance metrics based on test traffic messages received from the first device 102. The test setup request message may also include a time interval for which the first device 102 and the second device 108 will execute the test procedure.

Example message fields for the test setup request message are depicted by Table 1.

TABLE 1

| Size (bytes) | Field Name | Description |
|---|---|---|
| 6 | DA | Destination Address |
| 6 | SA | Source Address |
| 2 | MMTYPE | Indicates that this management |
| | | message is a test setup request |
| | | message. Example value: |
| | | 0xYYY0 (REQUEST) |
| 1 | MODE | MODE may be used to indicate the |
| | | type of testing procedures that are |
| | | requested. Example values may |
| | | include: |
| | | 0x00 = Mirror (Loopback) Mode |
| | | 0x01 = Unidirectional Mode |
| | | 0x02 = Bidirectional Mode |
| 1 | ROLES | ROLE may indicate which role the |
| | | receiving device should take for the |
| | | current test procedure |
| | | Example values may include: |
| | | Local → Remote |
| | | 0x00 = Server → Client |
| | | 0x01 = Client ← Server |
| 1 | TEST DURATION | Indicates the duration of the test |
| | | procedure. Example values: |
| | | 0x00 = Constant (run until told to |
| | | stop) |
| | | 0x01 = 1 minute |
| | | 0x02 = 2 minutes |
| | | 0x03 = 3 minutes |
| | | 0x04 = 4 minutes |
| | | 0x05 = 5 minutes |
| | | — |
| | | 0xFF = 255 minutes |
| 1 | TRAFFIC TYPE | Indicates the type of traffic that will |
| | | be sent during the test procedure. |
| | | Example values: |
| | | 0x00 = UDP |
| | | 0x01 = TCP |
| | | 0x02 and above = Reserved |
| 8 | NUMBYTESTX | Indicates the total number of bytes to |
| | | transmit for the test |
| 2 | PACKET LENGTH | Indicates the number of bytes in one |
| | | single packet |
| 2 | REPORT TYPE | Indicates how the receiving device |
| | | should report results of the test. |
| | | Example values: |
| | | 0x00 = Do not report after test ends |
| | | (default). Report can be requested |
| | | via a test results request message. |
| | | 0x01 = Send Test Result Report One |
| | | Time after Test Ends |
| | | 0x02 = Send Test Result Report |
| | | Constantly after Test Ends |
| | | 0x03 and above = Reserved |

In response to receiving the test setup request message 310, the second device 108 may determine from the test setup request message whether the second device 108 should be configured in the client operating mode. The second device 108 may determine (shown at 315) whether the second device 108 is capable of executing the test procedure identified in the test setup request message. The second device 108 can transmit a test setup confirmation message 320 to acknowledge receipt of the test setup request message. The test setup confirmation message 320 may also indicate whether the second device 108 will execute the requested test procedure. The test setup confirmation message 320 may also indicate that the second device 108 has been configured to operate in the client operating mode for the test procedure.

Example message fields for the test setup confirmation message 320 are depicted in Table 2

TABLE 2

| Size (bytes) | Field Name | Description |
|---|---|---|
| 6 | DA | Destination Address |
| 6 | SA | Source Address |
| 2 | MMTYPE | Indicates that this management |
| | | message is a test setup confirmation |
| | | message. Example value: |
| | | 0xYYY1 (CONFIRM) |
| 1 | STATUS | Indicates whether the test procedure |
| | | is acknowledged or if the test cannot |
| | | be performed. Example values: |
| | | 0x00 = Success |
| | | 0x01 = Failure (unable to conduct |
| | | test at this time) |

After receiving the test setup confirmation message 320 from the second device 108, the first device testing controller 104 may optionally transmit a test start message 330 to the second device 108. The test start message 330 may indicate that the first device 102 will start transmitting test traffic messages 350, 351. 352 to the second device 108. The test start message 330 may indicate a time period, time delay, or duration associated with the test traffic messages 350, 351, 352.

Example message fields for the test start message 330 are depicted in Table 3. The message format described in Table 3 may also be used as a test stop message, described below.

TABLE 3

| Size (bytes) | Field Name | Description |
|---|---|---|
| 6 | DA | Destination Address |
| 6 | SA | Source Address |
| 2 | MMTYPE | Indicates that this management |
| | | message is a test start or stop request |
| | | message. Example value: |
| | | 0xYYY4 (REQUEST) |
| 1 | MODE | Indicates the requested operation. |
| | | Example values: |
| | | 0x00 = START Test |
| | | 0x01 = STOP Test |

In some embodiments, after receiving the test start message 330 from the first device 102, the second device 108 may transmit a test start confirmation message 332 to the first device 102. Example message field for the test start confirmation message 332 are depicted in Table 4. The message format described in Table 4 may also be used as a test stop confirmation message, described below.

TABLE 4

| Size (bytes) | Field Name | Description |
|---|---|---|
| 6 | DA | Destination Address |
| 6 | SA | Source Address |
| 2 | MMTYPE | Indicates that this management |
| | | message is a test start or stop |
| | | confirmation message. Example |
| | | value: |
| | | 0xYYY5 (CONFIRM) |
| 1 | STATUS | Indicates confirmation of the |
| | | requested operation. Example |
| | | values: |
| | | 0x00 = Success |
| | | 0x01 = Failure (unable to conduct |
| | | test at this time) |

In one embodiment of a testing procedure, the first device 102 transmits test traffic messages 350, 351, 352 to the second device 108 after receiving the test setup confirmation message 320 or the test start confirmation message 332. The test traffic messages 350, 351, 352 may include predetermined data (or payload) for transmission to the second device 108. Alternatively, the test traffic messages 350, 351, 352 may include randomly generated data. The data/payload that is transmitted in the test traffic messages 350, 351, 352 may be determined based, at least in part, on a model or simulation of the traffic in the communication network. In some embodiments, the first device 102 may generate the data to be transmitted in the test traffic messages 350, 351, 352. For example, the first device testing controller (not shown) or a traffic generation unit (not shown) may be used to generate the data to be transmitted in the test traffic messages 350, 351, 352.

After the first device 102 transmits a predetermined number of test traffic messages 350, 351, 352 to the second device 108 and/or after the duration for conducting the test elapses, the first device 102 may transmit a test stop message 340 to the second device 108. The test stop message 340 may indicate that the first device 102 will not transmit additional test traffic messages to the second device 108 and that the second device 108 should end monitoring for the test traffic messages. An example format of the test stop message 340 is described in Table 3, above. In response to receiving the test stop message 340, the second device 108 may transmit a test stop confirmation message 342 to the first device 102. An example format of the test stop confirmation message 342 is described in Table 4, above.

In response to receiving the test stop confirmation message 342, the first device 102 may transmit a test results request message 360 to the second device 108. The test results request message 360 may indicate that the second device 108 should transmit the test results to the first device 102. In some embodiments, the test results request message 360 may also indicate what type of test results should be provided. For example, the test results request message 360 may indicate whether the second device 108 should provide the attenuation level and the signal-to-noise ratio (SNR) associated with the test traffic messages. Example message fields for the test results request message 360 are depicted in Table 5.

TABLE 5

| Size (bytes) | Field Name | Description |
|---|---|---|
| 6 | DA | Destination Address |
| 6 | SA | Source Address |
| 2 | MMTYPE | Indicates that this messages is a test |
| | | results request message. Example |
| | | value: |
| | | 0xYYY8 (REQUEST) |
| | DATA INCLUDED | Indicates the type of results |
| | | requested. Each bit may indicate a |
| | | different type of results requested. |
| | | Example values: |
| | | 0x00 = Bytes Rcd and Time Elapsed |
| | | 0b01 = Include SNR |
| | | 0b02 = Include PHY rates |
| | | 0b04 = Include Attenuation Level |
| | | 0b08 = 0 |
| | | 0b10 = 0 |
| | | 0b20 = 0 |
| | | 0b40 = 0 |
| | | 0b80 = 0 |

The second device 108 may determine the test results (shown at 355) from the test traffic message 350, 351, 352. In response to the test results request message 360, the second device 108 may transmit a test results confirmation message 362 including the test results. An example format of the test results confirmation message 362 will be further described in Table 6. Example test results that may be included in the test results confirmation message 362 will be further described in Table 7.

Example message fields for the test results confirmation message are depicted in Table 6.

TABLE 6

| Size (bytes) | Field Name | Description |
|---|---|---|
| 6 | DA | Destination Address |
| 6 | SA | Source Address |
| 2 | MMTYPE | Indicates that this message is a test |
| | | results confirmation message. |
| | | Example value: |
| | | 0xYYY9 (CONFIRM) |
| 1 | STATUS | Indicates whether the message |
| | | includes test results or if the test |
| | | failed to run. Example values: |
| | | 0x00 = Success |
| | | 0x01 = Failure (unable to run test) |
| 16 | TEST RESULT DATA | (See Table 7) |

Example message sub-fields for the test result data field are depicted in Table 7.

TABLE 7

| Size (bytes) | Field Name | Description |
|---|---|---|
| 8 | BYTES RECEIVED | Number of bytes of the test traffic |
| | | messages received |
| 8 | TIME ELAPSED | Time interval between the server |
| | | transmitting the test traffic messages |
| | | and the client receiving the test |
| | | traffic messages |
| X | SNR | Signal-to-noise ratio associated with |
| | | the received test traffic messages |
| X | PHY Rates | Physical layer data rate associated |
| | | with the received test traffic |
| | | messages |
| X | ATTENUATION | Attenuation level associated with the |
| | | received test traffic messages |

Although examples describe the first device 102 transmitting the test results request message 360 and the second device transmitting the test results confirmation message 362, embodiments are not so limited. In some embodiments, the first device 102 may notify the second device (e.g., in the test setup request message 310) to operate using the loopback test mode. In response to receiving a test traffic message 350,351,352 from the first device 102, the second device 108 may immediately retransmit the test traffic message (not shown) back to the first device 102. In the loopback test mode, because the first device 102 determines the performance metrics based on the test traffic messages retransmitted from the second device 108, the first device may not transmit the test results request message to the second device 108.

In some embodiments, after the first device 102 determines the performance of the second device 108, the second device 108 may execute the operations described above for testing the first device 102. For example, the second device 108 may transmit a test setup request message (not shown) to configure the second device 108 in the server operating mode and to configure the first device 102 in the client operating mode. The second device testing controller 110 may then transmit other test control messages (not shown) and test traffic messages as described above to estimate the performance of the first device 102.

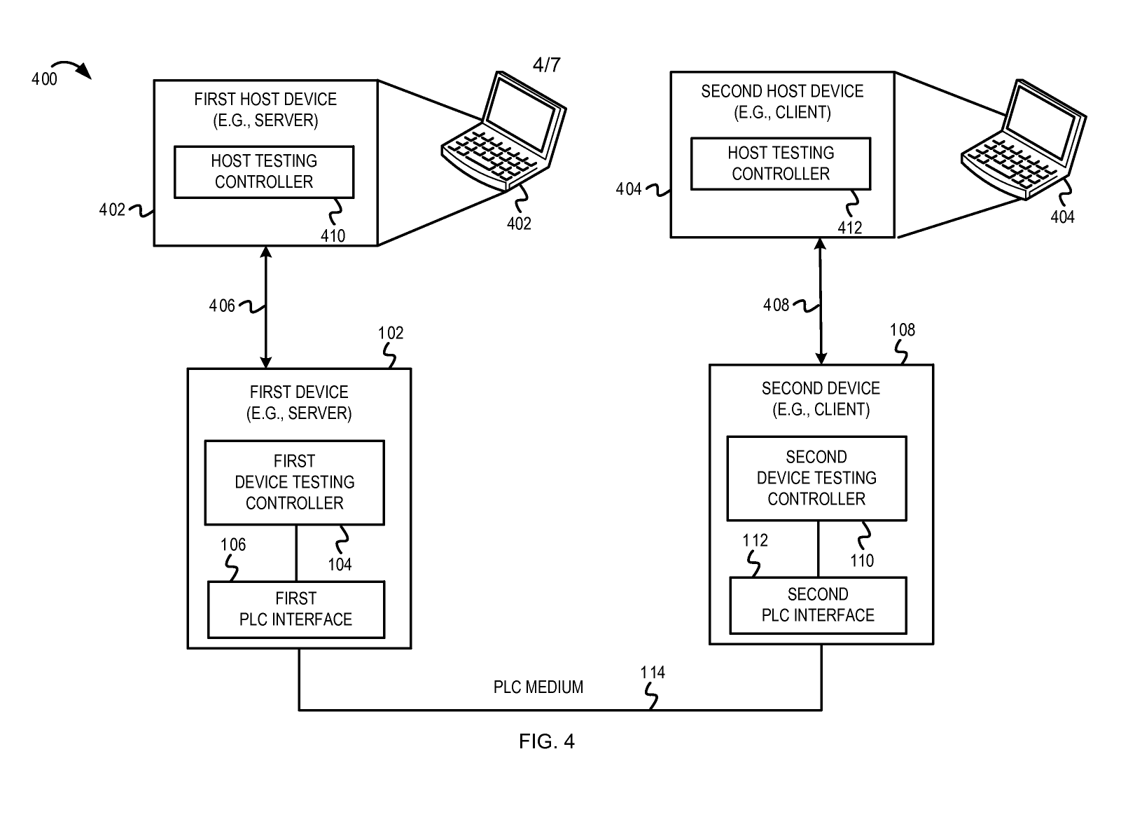

FIG. 4 is a conceptual diagram illustrating an example host device driven mechanism for testing a PLC device. FIG. 4 depicts a communication network 400 including the first device 102 and the second device 108. As depicted in FIG. 1, the first device 102 includes the first device testing controller 104 and the first PLC interface 106. Likewise, the second device 108 includes the second device testing controller 110 and the second PLC interface 112. The first PLC interface 106 of the first device 102 is coupled with the second PLC interface 112 of the second device 108 via the PLC medium 114. The communication network 400 also includes first and second host devices 402, 404. The first host device 402 is coupled with the first device 102 via a communication link 406; while the second host device 404 is coupled with the second device 108 via a communication link 408. In some embodiments, each host device may be coupled with the corresponding PLC-capable device via an HDMI interface or a Digital Visual Input (DVI) interface. In this embodiment, the communication links 406 and 408 may each be an HDMI communication link. In another embodiment, each host device may be coupled with the corresponding PLC-capable device via a UART interface, SPI interface, USB interface, or another network interface.

The first host device 402 includes a host testing controller 410. The second host device may or may not include a host testing controller 412. As will be further described below, the operations for testing an embedded PLC device may be driven by the external host device. In this embodiment, the testing functionality (e.g., the first and second device testing controllers 104, 110) implemented on the first and second devices 102, 108 may be bypassed in favor of the testing functionality on the first and second host devices 402, 404. In other words, in the example of FIG. 4, the host testing controllers 410 and 412 may execute the test operations described in this disclosure, such as those previously described with reference to the first and second device testing controllers 104, 110. The host testing controller may execute operations for: 1) conducting the test on a PLC device (e.g., transmitting test control messages for setting up, starting, stopping, synchronizing, and monitoring the test, and requesting test results), 2) self-generating test traffic messages on the PLC medium, and/or 3) determining performance metrics based on information received from the PLC device under test.

The first and second host devices 402, 404 may operate in a server operating mode or a client operating mode depending which of the PLC device 102, 108 is being tested. Referring to FIG. 4, a user may activate a trigger unit (not shown) associated with the first device 102 to initiate the test operations. Activating the trigger unit may include activating a physical button that is located on the first device 102, activating a virtual button that is presented on a display unit of the first device 102, triggering a switching unit associated with the first device 102, using a remote control or another suitable secondary trigger unit to wirelessly trigger the first device 102, etc. When the trigger unit associated with the first device 102 is activated, the first device 102 may transmit a notification to the first host device 402. The first host device 402 can configure itself in the server operating mode. As will be further described below, configuring the first host device 402 in the server operating mode indicates that the first host device 402 will conduct the test (along with the first device 102) to test a PLC interface of another device in the communication network 400. It is noted that in some embodiments, the trigger unit may be associated with the first host device 402. In this embodiment, the first host device 402 may operate in the server operating mode in response to activation of its trigger unit.

The host testing controller 410 (of the first host device 402) may detect the second device 108, and determine to test the second PLC interface 112 of the second device 108. The host testing controller 410 may generate a test setup request message to prompt the host testing controller 412 to initiate the test operations at the second host device 404. The test setup request message may include an indication that the second host device 404 (and the second device 108) should operate in the client operating mode. The test setup request message may also indicate a test mode, a time interval for executing the test operations, etc. as described with reference to FIGS. 1 and 3. In some embodiments, the host testing controller 410 may use a high-speed serial data transmission protocol (e.g., transition-minimized differential signaling (TMDS)) to encode the messages to be provided to the first device 102. TDMS is a technology for transmitting high-speed serial data, and is often used by high data rate video interfaces (such as HDMI). The host testing controller 410 may implement the high-speed serial data transmission protocol to transmit the test control messages and the test traffic messages concurrently with data packets (including non-test data) without affecting communication efficiency.

In accordance with the TMDS protocol, a transmitting device (e.g., the first host device 402) utilizes an encoding algorithm that minimizes electromagnetic interference over the communication medium and that enables robust clock recovery at a receiving device (e.g., the first device 102) to achieve high skew tolerance. To encode the test traffic messages and the test control messages, the host testing controller 410 may implement a two-stage TMDS protocol that converts an 8-bit input into a 10-bit output symbol. In the first stage, the first input bit is untransformed. Each subsequent input bit is either XOR or XNOR transformed against the previous input bit. Whether to execute XOR and XNOR transformation between two consecutive input bits is selected by determining which transformation will result in the fewest transitions in the output symbol. The ninth bit of the output symbol indicates whether the XOR transformation or XNOR transformation was performed. In the second stage, the first eight bits (after transformation) may be inverted to balance the number of ones and zeros in the output symbol and to have an approximately constant average DC level. The tenth bit of the output symbol indicates whether the inversion operations were performed.

After encoding the test setup request message, the host testing controller 410 may transmit the encoded test setup request message to the first device via the communication link 406 (e.g., an HDMI communication link, a DVI communication link, etc.). The first device testing controller 104 may forward the encoded test setup request message from the first PLC interface 106 of the first device 102 to the second PLC interface 112 of the second device 108 via the PLC medium 114. The second device testing controller 110 of the second device 108 may forward the test setup request message to the second host device 404. The host testing controller 412 may determine whether to operate in the client operating mode and whether to execute the test operations. The host testing controller 412 may generate a test setup confirmation message to acknowledge receipt of the test setup request message and to indicate whether the second host device 404 (and the second device 108) will execute the test operations. The host testing controller 412 may also encode the test setup confirmation message using the TMDS protocol and may transmit the encoded test setup confirmation message to the second device 108. The second device testing controller 110 may forward the encoded test setup confirmation message from the second PLC interface 112 of the second device 108 to the first PLC interface 106 of the first device 102. If determined to execute the test operations, the host testing controller 412 can configure the second host device 404 in the client operating mode.

After receiving the test setup confirmation message from the second device 108, the host testing controller 410 may transmit a test start message to the second host device 404 to indicate that the first host device 402 will start transmitting test traffic messages. The host testing controller 410 may generate the test start message, encode the test start message (e.g., using the TMDS protocol), and provide the encoded test start message to the first device 102. The first device testing controller 104 may forward the encoded test start message from the first PLC interface 106 to the second PLC interface 112 of the second device 108. The second device testing controller 110 may forward the encoded test start message to the second host device 404. In response, the host testing controller 412 may generate an encoded test start confirmation message and may similarly transmit the encoded test start confirmation message to the first host device 402 via the second device 108 and the first device 102.

The first host device 402 transmits the test traffic messages to the second host device 404 via the first device 102 and the second device 108 after receiving the test start confirmation message. In some embodiments, the first host device 402 may encode the test traffic messages prior to transmitting the test traffic messages. In other embodiments, however, the first host device 402 may not encode the test traffic messages to obtain an accurate representation of the performance of the second PLC interface 112 and the PLC medium.

After transmitting a predetermined number of test traffic messages and/or after the duration for transmitting the test traffic messages elapses, the host testing controller 410 may generate a test stop message. The test stop message may indicate that additional test traffic messages will not be transmitted. The host testing controller 410 may encode the test stop message and transmit the encoded test stop message to the second host device 404 via the first device 102 and the second device 108 as described above. In response to receiving the test stop message, the second host device 404 may transmit an encoded test stop confirmation message to the first host device 402. In response to receiving the test stop confirmation message, the host testing controller 410 may generate and transmit an encoded test results request message to the second host device 404 via the first device 102 and the second device 108. As described with reference to FIG. 1, the test results request message may indicate that the second host device 404 should start transmitting the test results to the first host device 402.

The host testing controller 412 and/or second device testing controller 110 may transmit a test results confirmation message including the test results in response to receiving the test results request message. Additionally, the host testing controller 412 may also determine how to transmit test results to the first host device 402 based, at least in part, on the test mode received from the first host device 402 in the test setup request message, as described above with reference to FIG. 1. For example, in the mirror or loopback test mode, the second host device 404 may retransmit the test traffic messages received from the first host device 402. The first host device 402 may estimate performance metrics associated with the second PLC interface 112 of the second device 108 based on the originally transmitted test traffic messages and the retransmitted test traffic messages. As another example, in the unidirectional test mode, the second host device 404 may estimate performance metrics of the second PLC interface 112 based on the test traffic messages received from the first host device 402. The second host device 404 may then transmit the performance metrics of the second PLC interface 112 to the first host device 402.

In some embodiments, the host testing controller 410 may also translate PLC-based performance metrics of the second PLC interface 112 to Ethernet-based performance metrics. The host testing controller 410 may use a PLC-to-Ethernet conversion mapping or a PLC-to-Ethernet conversion algorithm to determine the Ethernet-based performance metrics from the PLC-based performance metrics. By translating the PLC-based performance metrics to Ethernet-based performance metrics, the second device 108 (e.g., the second PLC interface 112) can be compared against other devices (e.g., PLC interfaces) that are associated with the Ethernet-based performance metrics.

In some embodiments, after the first host device 402 determines the performance of the second PLC interface 112 of the second device 108, the second host device 404 may execute the operations described above for testing the first PLC interface 106 of the first device 102 as described above with reference to FIGS. 1 and 3.

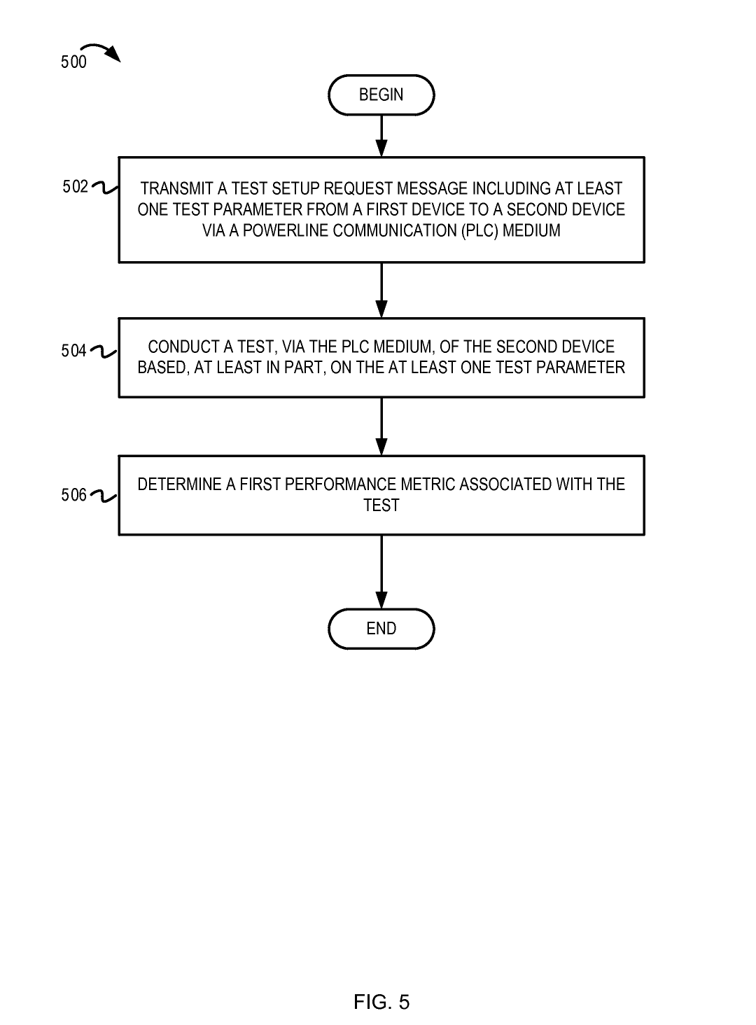

FIG. 5 is a flow diagram illustrating example operations for testing a powerline communication device. The flow 500 begins at block 502.

At block 502, a first device transmits a test setup request message including at least one test parameter to a second device via a powerline communication (PLC) medium. For example, the first device can transmit the test setup request message in response to detecting activation of a trigger unit associated with the first device. The test parameter can indicate which of the devices should be configured in the server operating mode and the client operating mode. In one embodiment, the first device may configure itself in the server operating mode in response to detecting activation of its trigger unit. The test parameter may indicate that the second device should be configured in the client operating mode. Configuring the second device in the client operating mode can indicate that first device will execute test operations to test the second device and the PLC medium. The test parameter may also indicate which test to conduct (e.g., a unidirectional test, a bidirectional test, a loopback test, etc.). Other test parameters could be indicated, including a test duration, traffic type, number of bytes that will be transmitted, packet length, etc. The flow continues at block 504.

At block 504, the first device conducts a test of the second device based, at least in part, on the at least one test parameter. After the first device is configured in the server operating mode and the second device is configured in the client operating mode, the first device can transmit a test start message to the second device. The test start message can indicate that the first device will start transmitting test traffic messages to test the PLC interface of the second device and to test the PLC medium. After receiving a test start confirmation message from the second device, the first device can start transmitting the test traffic messages. The number of test traffic messages transmitted may depend on the test parameters transmitted in the test setup request message. After the duration for conducting the test elapses (or after a predetermined number of test traffic messages have been transmitted), the first device transmits a test stop message to the second device to indicate that additional test traffic messages will not be transmitted. After receiving a test stop confirmation message from the second device, the first device can transmit a test results request message to the second device. The first device can transmit the test results request message to prompt the second device to transmit test results to the first device. The flow continues at block 506.

At block 506, the first device determines a performance metric associated with the test. In response to transmitting the test results request message, the first device may receive a test results confirmation message from the second device. The test results confirmation message may include test results as described above with reference to FIG. 3. In one embodiment, the first device may receive the test results from the second device. The test results may include 1) the number of bytes received at the second device from the first device, 2) the time elapsed between the first device transmitting the test traffic messages and the second device receiving the test traffic messages, 3) the signal-to-noise ratio (SNR) associated with the test traffic messages, 4) the data rate associated with the test traffic messages, 5) the attenuation associated with the test traffic messages, and/or other suitable performance metrics.

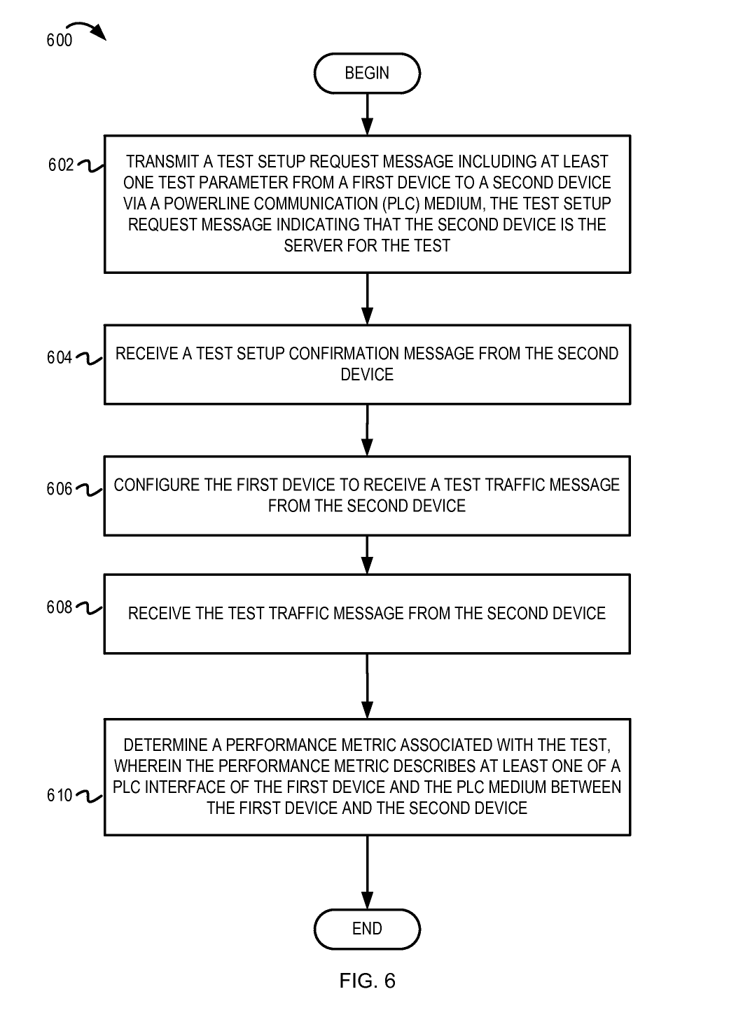

FIG. 6 is a flow diagram (“flow”) illustrating example operations for conducting a test in which the second device sends the test traffic messages.

At block 602, a first device may transmit a test setup request message including at least one test parameter from a first device to a second device via a powerline communication (PLC) medium, the test setup request message indicating that the second device is the server for the test. At block 604, the first device may receive a test setup confirmation message from the second device. At block 606, the first device may configure itself to receive a test traffic message from the second device. At block 608, the first device may receive the test traffic message from the second device. The test traffic message may include predetermined test data known to the first device and the second device. At block 610, the first device may determine a performance metric associated with the test, wherein the performance metric describes at least one of a PLC interface of the first device and the PLC medium between the first device and the second device.

In another embodiment, the first device can send test traffic messages (not shown) and subsequently receive a re-transmission of the test traffic messages from the second device. The test traffic messages re-transmitted from the second device may be a mirrored transmission of the test traffic messages originally transmitted by the first device. The first device may estimate the performance of the PLC interface of the second device based on the test traffic messages originally transmitted from the first device and the retransmitted test traffic messages received from the second device. Additionally, the first device may estimate the performance (e.g., bandwidth) of the PLC medium between the first device and the second device.

In some embodiments, the first device may translate the PLC-based performance metrics determined on the PLC medium to corresponding Ethernet-based performance metrics associated with the Ethernet medium. The translated performance metrics may be used to compare the PLC interface of the second device relative to a PLC interface of another device that was tested using an Ethernet interface.

The Figures in this disclosure, including FIGS. 1-6, are examples meant to aid in understanding embodiments and should not be used to limit embodiments or scope of the claims. Embodiments may comprise additional components, different components, and/or may perform additional operations, fewer operations, operations in a different order, operations in parallel, and some operations differently. The tests described in this disclosure may be used to measure physical (PHY) layer performance of a PLC interface of a second device, or may also be used to measure media access control (MAC) layer performance of the second device.

For example, PHY layer performance may be measured for a PLC embedded device. The PLC embedded device may implement the features described herein to initiate a test responsive to activation of a trigger unit. In one embodiment, a user can cause the PLC embedded device to initiate a test mode (e.g., by pressing a push button or other activation means). Upon activation, the PLC embedded device initiates the embedded test mode setup process. For example, the PLC embedded device may configure itself as server and send a command to a second PLC device requesting the second PLC device to configure itself as client. The server and client may communicate the test parameters using management messages as described herein to perform tests of the PHY layer performance.

MAC layer performance metrics may also be measured using the techniques described herein. For example, the tests described in FIG. 4 may be used to measure MAC layer performance when the control management messages are sent or received by a host device. The host device may manage the test parameters using MAC layer or higher layer messages sent via the PHY/MAC layers of the PLC embedded device.

Although the Figures describe the first device configuring itself in the server operating mode if the trigger unit associated with the first device is activated, embodiments are not so limited. In other embodiments, the first device may configure itself in the client operating mode after detecting activation of its trigger unit. The first device may transmit a test setup request message to the second device. The test parameters in the test setup request message may indicate that the second device should configure itself in the server operating mode to test the PLC interface of the first device. After configuring itself in the server operating mode, the second device may transmit other test control messages (e.g., the test start message, test stop message, test results request message, etc.) and the test traffic messages to the first device to conduct the test. The second device can test the performance of the PLC interface of the first device based on test results received from the first device as similarly described above with reference to FIGS. 1-6.

Although the Figures describe the first device transmitting test control messages and test traffic messages to the second device to test the performance of the second device, embodiments are not so limited. In other embodiments, the first device may transmit the test control messages and the test traffic messages to the second device to test the performance of the PLC interface of the first device. The first device may transmit the test traffic messages to the second device. In one embodiment, the second device may estimate the performance of the PLC interface of the first device based on the test traffic messages received from the first device. In another embodiment, the second device may re-transmit the test traffic messages to the first network device. The first network device may estimate the performance of its PLC interface based on the test traffic messages transmitted from the first device and the retransmitted test traffic messages received from the second device.

Although the host-driven testing mechanism of FIG. 4 depicts the first device and the second device each connected to a respective host device, embodiments are not so limited. In other embodiments, only one of the PLC-capable devices may be coupled with a host device. In one implementation, the PLC-capable device conducting the test (and configured in the server operating mode) may be coupled with a host device. The PLC-capable device under test (and configured in the client operating mode) may not be coupled with a host device. Referring to the example of FIG. 4, the first device 102 may be coupled with the first host device 402; however, the second device 108 may not be coupled with the second host device 404. In some embodiments, if the second device 108 is not coupled with the second host device 404, the first host device 402 may not encode the test control messages to enable the second device 108 to conduct the test. In this embodiment, the test parameters in the test setup request message may indicate that the second device 108 should operating in the loopback test mode and should re-transmit the test traffic messages to the first device 102. In another embodiment, if the second device 108 is not coupled with the second host device 404, the first host device may encode the test control messages if the second device 108 implements functionality for decoding the encoded test control messages.

In another implementation, the PLC-capable device under test (and configured in the client operating mode) may be coupled with a host device. The PLC-capable device conducting the test (and configured in the server operating mode) may not be coupled with a host device. Referring to the example of FIG. 4, the first device 102 may be not coupled with the first host device 402; however, the second device 108 may be coupled (shown at 408) with the second host device 404. In this implementation, the first device 102 may generate and transmit test control messages and test traffic messages to the second device 108. The second device 108 may forward the test control messages and the test traffic messages to the second host device 404. The second host device 404 may process the test control messages and the test traffic messages, generate confirmation messages, and/or generate test results. The second device 108 may receive the confirmation messages and the test results from the second host device 404 for forwarding to the first device 102.

In one embodiment, a communication system may include a first device communicatively coupled with a second device for performance testing. The first device may be configured to transmit a test setup request message including test parameters to the second device via a powerline communication (PLC) medium. The first device may be configured to conduct a test of a PLC interface of the second device in accordance with the test parameters and determine a performance metric associated with the PLC interface of the second device based, at least in part, on the test. The second device may be configured to determine how to transmit test results to the first device based, at least in part, on the test parameters in the test setup request message.

As will be appreciated by one skilled in the art, aspects of the present subject matter may be embodied as a system, method, or computer program product. Accordingly, aspects of the present subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present subject matter are described with reference to flowchart illustrations and/or block diagrams of methods, apparatus (systems) and computer program products according to embodiments of the present subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

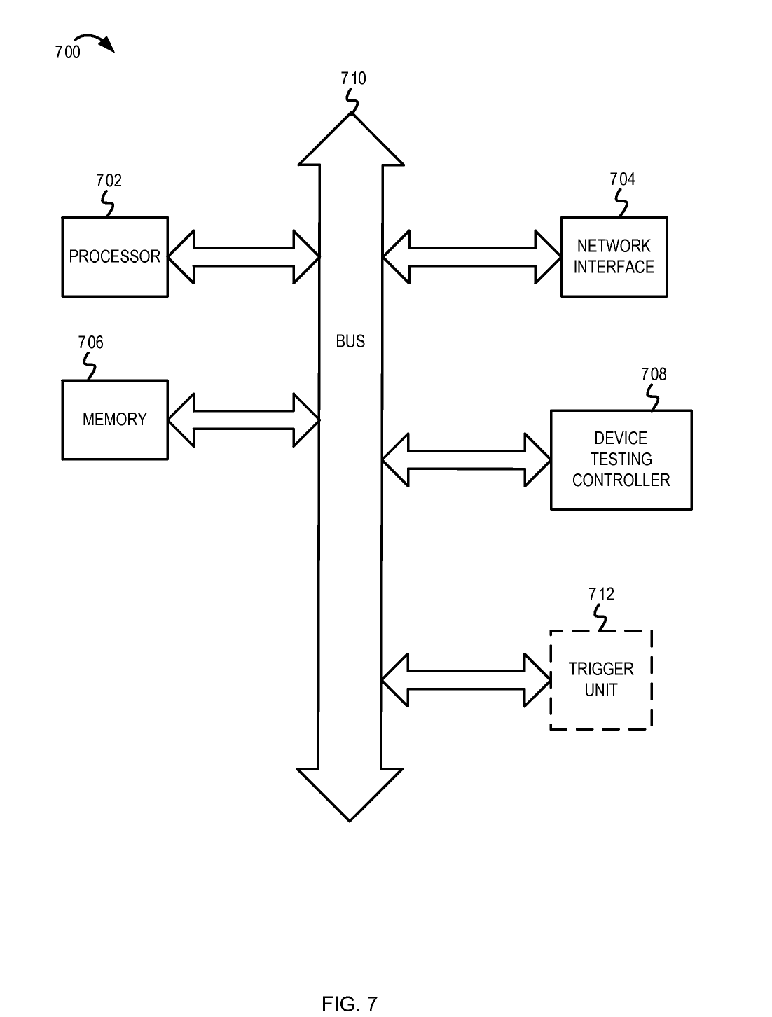

FIG. 7 is a block diagram of one embodiment of an electronic device 700 including a mechanism for testing a PLC device. In some implementations, the electronic device 700 may be one of a desktop computer, a laptop computer, a tablet computer, a smart appliance, a gaming console, a television, a television set-top box (or set-top unit), a media player, a PLC modem, or another electronic device including powerline communication capabilities. For example, the electronic device 700 may include an embedded PLC device. In another implementation, the electronic device 700 may be a host device that is communicatively coupled with a PLC-capable device. The electronic device 700 includes a processor 702 (possibly including multiple processors, multiple cores, multiple nodes, and/or implementing multi-threading, etc.). The electronic device 700 includes a memory 706. The memory 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The electronic device 700 also includes a bus 710 (e.g., PCI, ISA, PCI-Express, HyperTransport®, InfiniBand®, NuBus, AHB, AXI, etc.). The electronic device 700 also includes a network interface 704, also referred to as a port. The network interface 704 can include a wireless network interface (e.g., a WLAN interface, a Bluetooth® interface, a WiMAX interface, a ZigBee® interface, a Wireless USB interface, etc.) and/or a wired network interface (e.g., a PLC interface, an HDMI interface, SPI interface, etc.). Furthermore, in some embodiments, the electronic device 700 can execute an IEEE Std. 1905.1 protocol for implementing hybrid communication functionality.

The electronic device 700 also includes a device testing controller 708. In some embodiments, the device testing controller 708 may implement functionality to test the performance of the PLC interface of another electronic device. The device testing controller 708 can transmit test control messages to configure another electronic device in a client operating mode (“client electronic device”) and to subsequently test the PLC interface of the client electronic device. The device testing controller 708 may transmit test traffic messages to the client electronic device and determine test results based on information received from the client electronic device. The device testing controller 708 may determine the performance of the PLC interface of the client electronic device and the PLC medium from the test results as described above. In another implementation, the electronic device 700 may be a host device that is communicatively coupled with and that drives a PLC-capable device. In this implementation, the device testing controller 708 (of the host device) can generate test control messages and test traffic messages for testing the client electronic device and the PLC medium. The device testing controller 708 may or may not encode the test control messages and the test traffic messages depending on whether the client electronic device is communicatively coupled with a host device. The device testing controller 708 may determine test results based on information received from the client electronic device. The device testing controller 708 may determine the performance of the PLC interface of the client electronic device and the PLC medium from the test results as described above. In some embodiments, the electronic device 700 may include a trigger unit 712, a virtual button on a display (not shown), a switch (not shown), or other activation means capable of detecting an activation request by a user. Responsive to the activation request, the electronic device 700 may initiate a test procedure such as those described above.

Any one of these functionalities may be partially (or entirely) implemented in hardware and/or on the processor 702. For example, the functionality may be implemented with an application specific integrated circuit (ASIC), in logic implemented in the processor 702, in a co-processor on a peripheral device or card, etc. In some embodiments, the device testing controller 708 can each be implemented on a system-on-a-chip (SoC), an ASIC, or another suitable integrated circuit to enable communications of the electronic device 700. In some embodiments, the device testing controller 708 may include additional processors and memory, and may be implemented in one or more integrated circuits on one or more circuit boards of the electronic device 700. Further, realizations may include fewer or additional components not illustrated in FIG. 7 (e.g., video cards, audio cards, additional network interfaces, peripheral devices, etc.). For example, in addition to the processor 702 coupled with the bus 710, the device testing controller 708 may include at least one additional processors. As another example, although illustrated as being coupled to the bus 710, the memory 706 may be coupled to the processor 702. As another example, the electronic device 700 may include one or more radio transceivers, processors, memory, and/or other logic to implement the communication protocols and related functionality.

While the embodiments are described with reference to various implementations and exploitations, it will be understood that these embodiments are illustrative and that the scope of the present subject matter is not limited to them. In general, techniques for testing PLC devices as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present subject matter.

What is claimed is:

1. A method for testing a powerline communication (PLC) device, the method comprising:
transmitting a test setup request message from a first device to a second device via a PLC medium, the test setup request message including at least one test parameter;
conducting a test, via the PLC medium, of the second device in accordance with the at least one test parameter; and
determining a first performance metric associated with the test.

2. The method of claim 1, wherein the at least one test parameter includes an indication to designate one of the first device and the second device as a server and to designate the other of the first device and the second device as a client.

3. The method of claim 1, further comprising:
detecting an activation of a trigger unit associated with the first device, wherein said transmitting the test setup request message is responsive to detecting the activation of the trigger unit.

4. The method of claim 1, wherein the first performance metric describes at least one of a PLC interface of the second device and the PLC medium between the first device and the second device.

5. The method of claim 1, further comprising:
receiving a test setup confirmation message at the first device from the second device in response to the test setup request message,
wherein conducting the test comprises transmitting a first test traffic message from the first device to the second device in response to receiving the test setup confirmation message from the second device.

6. The method of claim 1, wherein conducting the test comprises at least one of:
transmitting a test traffic message to test a physical (PHY) layer performance of the second device; and
transmitting the test traffic message to test a medium access control (MAC) layer performance of the second device.

7. The method of claim 1, wherein said transmitting the test setup request message comprises providing an indication of a test procedure from a plurality of test procedures.

8. The method of claim 7, wherein the test procedure causes the second device to determine the first performance metric and send the first performance metric to the first device.

9. The method of claim 1,
wherein said transmitting the test setup request message comprises providing an indication that the test is a loopback test; and
wherein conducting the test comprises:
transmitting a first test traffic message from the first device to the second device; and
receiving a second test traffic message at the first device from the second device, the second test traffic message representing a mirrored transmission of the first test traffic message.

10. The method of claim 9, wherein said determining the first performance metric is based, at least in part, on a comparison of the first test traffic message transmitted by the first device and the second test traffic message received from the second device.

11. The method of claim 1, wherein determining the first performance metric comprises:
receiving the first performance metric from the second device, the first performance metric determined by the second device based, at least in part, on a test traffic message transmitted by the first device in accordance with the at least one test parameter.

12. The method of claim 1, wherein conducting the test comprises:
receiving a first test traffic message from a host device for transmission to the second device, the first test traffic message encoded using a first communication protocol associated with the host device, wherein the host device is communicatively coupled with the first device; and
transmitting the first test traffic message to the second device.

13. The method of claim 1, further comprising:
transmitting a test start message from the first device to the second device prior to transmitting a test traffic message; and
transmitting a test stop message from the first device to the second device in response to determining that a duration for conducting the test has elapsed.

14. The method of claim 1, further comprising:
transmitting a test results request message from the first device to the second device to cause the second device to transmit test results to the first device; and
receiving a test results confirmation message from the second device, wherein the test results confirmation message includes the first performance metric.

15. The method of claim 1, further comprising:
conducting a second test, via the PLC medium, wherein the second test comprises receiving a test traffic message at the first device from the second device via the PLC medium; and
determining a second performance metric associated with second test, wherein the second performance metric describes at least one of a PLC interface of the first device and the PLC medium between the first device and the second device.

16. The method of claim 1, wherein said conducting the test is in response to determining that the second device does not include Ethernet communication capabilities.

17. The method of claim 1, further comprising:
translating the first performance metric of the second device from a PLC-based performance metric to an Ethernet-based performance metric.

18. A first device comprising:
a processor; and
memory for storing instructions therein which, when executed by the processor, cause the first device to:
transmit a test setup request message to a second device via a powerline communication (PLC) medium, the test setup request message including at least one test parameter;
conduct a test, via the PLC medium, of the second device in accordance with the at least one test parameter; and
determine a performance metric associated with the test.

19. The first device of claim 18, further comprising:
a trigger unit configured to detect a user activation, wherein the test setup request message is transmitted in response to detecting the user activation.

20. The first device of claim 18, wherein the instructions, when executed by the processor, further cause the first device to:
receive a test setup confirmation message at the first device from the second device in response to the test setup request message; and
transmit a first test traffic message from the first device to the second device in response to receiving the test setup confirmation message from the second device.

21. The first device of claim 18, wherein the instructions, when executed by the processor, further cause the first device to provide, in the test setup request message, an indication of which test to conduct, wherein the test is selected from a group consisting of a unidirectional test, a bidirectional test, and a loopback test.

22. The first device of claim 18, wherein the first device is an embedded powerline communication device.

23. A non-transitory machine-readable storage medium having instructions stored therein, which when executed by a processor causes the processor to:
transmit a test setup request message from a first device to a second device via a powerline communication (PLC) medium, the test setup request message including at least one test parameter;
conduct a test, via the PLC medium, of the second device in accordance with the at least one test parameter; and
determine a first performance metric associated with the PLC interface of the second device based, at least in part, on the test.

24. The non-transitory machine-readable storage medium of claim 23, wherein the test parameters include an indication to designate one of the first device and the second device as a server and to designate other of the first device and the second device as a client.

25. The non-transitory machine-readable storage medium of claim 23, wherein the instructions stored therein, when executed by the processor cause the processor to:
detect an activation of a trigger unit associated with the first device, wherein said transmitting the test setup request message is responsive to detecting the activation of the trigger unit.

26. The non-transitory machine-readable storage medium of claim 23, wherein the instructions stored therein, when executed by the processor further cause the processor to:
receive test setup confirmation message at the first device from the second device in response to the test setup request message,
wherein conducting the test comprises transmitting a first test traffic message from the first device to the second device in response to receiving the test setup confirmation message from the second device.

27. The non-transitory machine-readable storage medium of claim 23, wherein the instructions stored therein, when executed by the processor further cause the processor to:
provide, in the test setup request message, an indication of which test to conduct, wherein the test is selected from a group consisting of a unidirectional test, a bidirectional test, and a loopback test.

28. The non-transitory machine-readable storage medium of claim 23, wherein the instructions stored therein, when executed by the processor further cause the processor to:
provide, in the test setup request message, an indication that the test is a loopback test; and
wherein the instructions that cause the processor to conduct the test comprise instructions that cause the processor to:
transmit a first test traffic message from the first device to the second device;
receive a second test traffic message at the first device from the second device, the second test traffic message representing a mirrored transmission of the first test traffic message; and
wherein the instructions that cause the processor to determine the first performance metric comprise instructions that cause the processor to:
determine the first performance metric based, at least in part, on a comparison of the first test traffic message transmitted by the first device and the second test traffic message received from the second device.

29. The non-transitory machine-readable storage medium of claim 23, wherein the instructions that cause the processor to conduct the test comprise instructions which cause the processor to:
receive a first test traffic message from a host device for transmission to the second device, the first test traffic message encoded using a first communication protocol associated with the host device, wherein the host device is communicatively coupled with the first device; and
transmit the first test traffic message to the second device.

30. The non-transitory machine-readable storage medium of claim 23, wherein the instructions, when executed by the processor, cause the processor to:
translate the first performance metric of the second device from a PLC-based performance metric to an Ethernet-based performance metric.
